(19) United States
(12) Patent Application Publication
(10) Pub. No.: US 2018/0241046 A1
(43) Pub. Date: Aug. 23, 2018

(54) CATALYST LAYER FOR FUEL CELL ELECTRODE AND METHOD OF PRODUCING THE SAME

(71) Applicants: TOYOTA JIDOSHA KABUSHIKI KAISHA, Toyota-shi (JP); CATALER CORPORATION, Kakegawa-shi (JP)

(72) Inventors: Yusuke Itoh, Nagoya-shi (JP); Mikihiro Hori, Nagoya-shi (JP); Mikihiro Kataoka, Kakegawa-shi (JP); Kenji Yamamoto, Kakegawa-shi (JP); Kotaro Horiai, Kakegawa-shi (JP); Yuki Makino, Kakegawa-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 15/899,502

(22) Filed: Feb. 20, 2018

(30) Foreign Application Priority Data
Feb. 20, 2017 (JP) 2017-029409

(51) Int. Cl. H01M 4/90; H01M 4/86; C08L 27/12

(52) U.S. Cl. CPC H01M 4/9083; H01M 4/8668; C01P 2004/03; C08L 2203/20; C01B 2204/32; C08L 27/12

(57) ABSTRACT

There are provided a catalyst layer for a fuel cell electrode and a method of producing the same. The catalyst layer for a fuel cell electrode includes a metal-supported catalyst including a carbon carrier and a metal catalyst supported on the carbon carrier and a fluororesin ionomer. A value obtained when a primary particle diameter of the carbon carrier measured with an SEM, a pH value of the metal-supported catalyst measured by a specific method, and a ratio between a weight of the fluororesin ionomer and a weight of the carbon carrier of the metal-supported catalyst are applied to a specific formula is a certain value or more.

### INCORPORATION BY REFERENCE

The disclosure of Japanese Patent Application No. 2017-029409 filed on Feb. 20, 2017 including the specification, drawings and abstract is incorporated herein by reference in its entirety.

### BACKGROUND

### 1. Technical Field

The present disclosure relates to a catalyst layer for a fuel cell electrode and a method of producing the same.

### 2. Description of Related Art

A solid polymer fuel cell includes a membrane electrode assembly (“fuel electrode-solid polymer electrolyte film-air electrode”) (hereinafter referred to as an “MEA”) in which an electrode is bonded to both surfaces of a solid polymer electrolyte film as a basic unit. Generally, a gas diffusion layer is additionally bonded to both surfaces of the MEA, and this assembly is called a membrane electrode gas diffusion layer assembly (“gas diffusion layer-MEA-gas diffusion layer”) (hereinafter referred to as an “MEGA”).

Each electrode includes a catalyst layer. The catalyst layer is a layer in which an electrode reaction occurs due to an electrode catalyst contained in the catalyst layer. In order to allow an electrode reaction to progress, a three-phase interface at which three phases including an electrolyte, a catalyst, and a reaction gas exist together is necessary. Therefore, the catalyst layer is generally a layer that includes a catalyst (here, the catalyst includes not only a catalyst that functions alone but also a metal catalyst supported on a carrier (hereinafter referred to as a metal-supported catalyst)) and an electrolyte. In addition, the gas diffusion layer is a layer for supplying a reaction gas to the catalyst layer and transmitting and receiving electrons and a porous material having electron conductivity is used therefor.

In such an MEGA, the bonding strength between the MEA and the gas diffusion layer is a factor influencing performance of the electrode. Therefore, various studies are proceeding in order to improve the bonding strength between the MEA and the gas diffusion layer, and particularly, the peel strength.

For example, in Japanese Unexamined Patent Application Publication No. 2013-93166 (JP 2013-93166 A), a catalyst ink for producing an electrode, which includes catalyst supporting particles and an ionomer, is described. In the catalyst ink, an amount of an adsorbed ionomer adsorbed on the surface of catalyst supporting particles and an amount of a non-adsorbed (free) ionomer that is not adsorbed on the surface of catalyst supporting particles are controlled. When amounts of the ionomers in the catalyst ink are controlled, a catalyst layer in which an amount of an ionomer on the surface of the catalyst layer is high is formed. As a result, the peel strength between the MEA and the gas diffusion layer is improved.

### SUMMARY

However, in the catalyst ink described in JP 2013-93166 A, when an amount of the non-adsorbed ionomer increases, an amount of an ionomer covering the surface of catalyst particles decreases. As a result, a proton conduction path occurring in a fuel electrode decreases and eventually, the conductivity of the electrode decreases, and additionally, the performance of the electrode deteriorates.

The present disclosure provides a catalyst layer for a fuel cell electrode through which it is possible to increase the peel strength between an MEA and a gas diffusion layer without increasing an amount of a non-adsorbed ionomer and a method of producing the same.

The inventors conducted studies on various methods for addressing the above problem, and found the result that, in a catalyst layer for a fuel cell electrode including a metal-supported catalyst including a carbon carrier and a metal catalyst supported on the carbon carrier and a fluororesin ionomer, when a value obtained when a primary particle diameter (nm) of the carbon carrier measured with an SEM, a pH value of the metal-supported catalyst measured by a specific method, and a ratio between a weight of the fluororesin ionomer and a weight of the carbon carrier of the metal-supported catalyst are applied to a specific formula is a certain value or more, the peel strength between the obtained catalyst layer for a fuel cell electrode and the gas diffusion layer is high, thus completing the present disclosure.

The present disclosure relates to a catalyst layer for a fuel cell electrode including a metal-supported catalyst including a carbon carrier and a metal catalyst supported on the carbon carrier and a fluororesin ionomer. In the catalyst layer, when a primary particle diameter of the carbon carrier measured with an SEM is set as D (nm), a pH value of a suspension obtained when 0.5 g of the metal-supported catalyst is suspended in 30 ml water and then stirred for 30 minutes is set as A, a weight of the fluororesin ionomer is set as I, and a weight of the carbon carrier of the metal-supported catalyst is set as C, the following formula is satisfied.

0.42×D−1.96×A+16×I/C≥18

The present disclosure relates to a method of producing a catalyst layer for a fuel cell electrode including a metal-supported catalyst and a fluororesin ionomer. The method includes preparing a metal-supported catalyst by supporting a metal catalyst on a carbon carrier, adjusting a pH value of a suspension of the prepared metal-supported catalyst obtained when 0.5 g of the metal-supported catalyst is suspended in 30 ml water and then stirred for 30 minutes, preparing a catalyst ink by mixing the metal-supported catalyst whose pH value is adjusted with a fluororesin ionomer, and preparing a catalyst layer for a fuel cell electrode from the prepared catalyst ink. In the method, when a primary particle diameter of the carbon carrier measured with an SEM is set as D (nm), the pH value is set as A, a weight of the fluororesin ionomer is set as I, and a weight of the carbon carrier of the metal-supported catalyst is set as C, the following formula is satisfied.

0.42×D−1.96×A+16×I/C≥18

The present disclosure provides a catalyst layer for a fuel cell electrode through which it is possible to increase the peel strength between a catalyst layer and a gas diffusion layer, that is, the peel strength between an MEA and a gas diffusion layer, without increasing an amount of a non-adsorbed ionomer, and method of producing the same.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically showing a state in which fluororesin ionomers are provided in a catalyst layer for a fuel cell electrode; and

FIG. 2 is a diagram showing the peel strength of electrode sheets prepared in Examples 1 to 6 and Comparative Examples 1 to 3 with respect to a catalyst water immersion pH.

### DETAILED DESCRIPTION OF EMBODIMENTS

Exemplary embodiments of the present disclosure will be described below in detail. In this specification, features of the present disclosure will be appropriately described with reference to the drawings. In the drawings, sizes and shapes of respective components are exaggerated for clarity and do not accurately reflect actual sizes and shapes. Therefore, the technical scope of the present disclosure is not limited to the sizes and shapes of respective components shown in the drawings. Here, a catalyst layer for a fuel cell electrode and a method of producing the same according to the present disclosure are not limited to the following embodiments, and can be realized in various modes that may be modified and improved by those skilled in the art without departing from the spirit and scope of the present disclosure.

The catalyst layer for a fuel cell electrode of the present disclosure (in this specification and the like (including claims and drawings, hereinafter the same), simply referred to as a “catalyst layer”) includes a metal-supported catalyst including a carbon carrier and a metal catalyst, and a fluororesin ionomer.

In the catalyst layer for a fuel cell electrode of the present disclosure, when a primary particle diameter of a carbon carrier measured with an SEM is set as “D (nm)” (in this specification and the like, simply referred to as “D (nm)”), a pH value of a suspension in which 0.5 g of a metal-supported catalyst is suspended in 30 ml water and then stirred for 30 minutes is set as A (in this specification and the like, simply referred to as a “catalyst water immersion pH value” or “A”), a weight of a fluororesin ionomer is set as I, and a weight of the carbon carrier of the metal-supported catalyst is set as C, a value “X” (in this specification and the like, simply referred to as “X”) in the following Formula (1) satisfies X≥18, preferably, X≥2.0, and more preferably, X≥22.

X=0.42×D−1.96×A+16×I/C (1)

The primary particle diameter “D (nm)” of the carbon carrier of the metal-supported catalyst used for the catalyst layer for a fuel cell electrode of the present disclosure which is measured with an SEM is generally 18 nm or more, preferably 23 nm or more, and more preferably 40 nm or more.

Here, for the primary particle diameter “D (nm)” of the carbon carrier measured with an SEM, 50 primary particles are extracted from an SEM image captured under a field emission scanning electron microscope, diameters of the particles are set as diameters of circles having the same area as an area of an external shape of each particle, and an average value of the diameters of the particles is set as a primary particle diameter “D (nm).”

The catalyst water immersion pH value “A” of the metal-supported catalyst used for the catalyst layer for a fuel cell electrode of the present disclosure is generally 7.4 or less, preferably 4.5 or less, and more preferably 3.5 or less.

Here, as described above, the catalyst water immersion pH value is a pH value of a suspension in which 0.5 g of a metal-supported catalyst is suspended in 30 ml pure water and then stirred at room temperature (20° C. to 30° C., for example, 25° C.) for 30 minutes.

The ratio “I/C” ((in this specification and the like, simply referred to as “I/C”) between the weight (I) of the fluororesin ionomer and the weight (C) of the carbon carrier of the metal-supported catalyst used for the catalyst layer for a fuel cell electrode of the present disclosure is generally 0.8 or more, preferably 1.0 or more, and more preferably 1.2 or more.

The peel strength between the catalyst layer and the gas diffusion layer in the catalyst layer for a fuel cell electrode of the present disclosure is higher as the thickness, distribution, and amount of the fluororesin ionomer on the surface of the catalyst layer increase.

The thickness of the fluororesin ionomer on the surface of the catalyst layer depends on the area covered by the fluororesin ionomer. As the area covered by the fluororesin ionomer decreases, the thickness of the fluororesin ionomer on the surface of the catalyst layer increases. Here, when the weight or volume of the metal-supported catalyst covered by the fluororesin ionomer is constant, the area covered by the fluororesin ionomer depends on the primary particle diameter of the carbon carrier of the metal-supported catalyst covered by the fluororesin ionomer measured with an SEM. When the primary particle diameter of the carbon carrier measured with an SEM increases, the area covered by the fluororesin ionomer decreases and the thickness of the fluororesin ionomer on the surface of the catalyst layer increases.

The distribution of fluororesin ionomer on the surface of the catalyst layer depends on the viscosity of the catalyst ink when the catalyst layer is produced. When the viscosity of the catalyst ink decreases, the distribution of fluororesin ionomer on the surface of the catalyst layer increases. Here, the viscosity of the catalyst ink depends on the catalyst water immersion pH value. When the catalyst water immersion pH value decreases, the viscosity of the catalyst ink decreases, and the distribution of fluororesin ionomer on the surface of the catalyst layer increases.

An amount of the fluororesin ionomer on the surface of the catalyst layer depends on a total amount of the fluororesin ionomer. When a total amount of the fluororesin ionomer increases, an amount of the fluororesin ionomer on the surface of the catalyst layer increases.

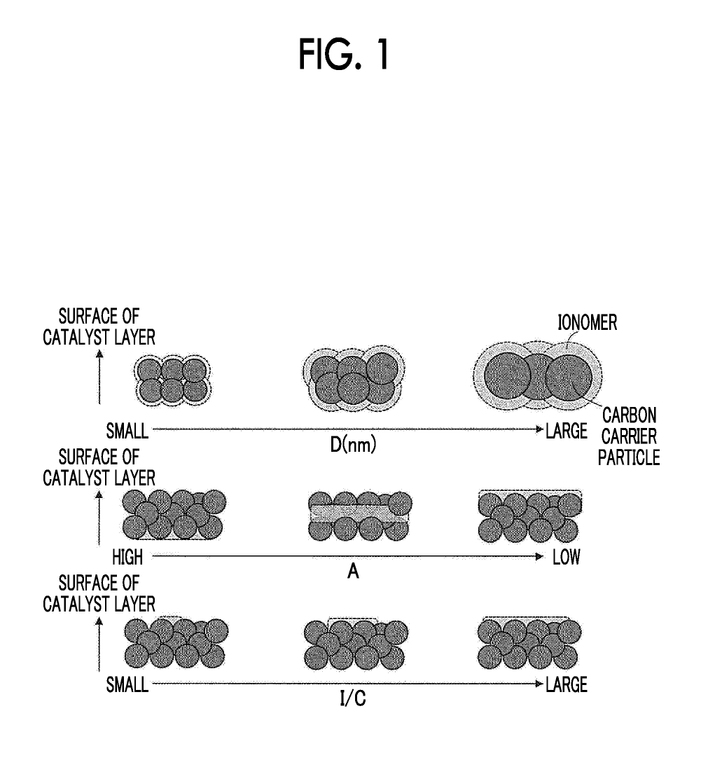

Therefore, in the catalyst layer for a fuel cell electrode of the present disclosure, as shown in FIG. 1,

(1) when the primary particle diameter “D (nm)” of the carbon carrier of the metal-supported catalyst measured with an SEM which is an index of the area covered by the fluororesin ionomer increases, the thickness of the fluororesin ionomer increases,
(2) when the catalyst water immersion pH value “A” which is an index of the viscosity of the catalyst ink decreases, the distribution of fluororesin ionomer on the surface of the catalyst layer increases, and
(3) when the ratio “I/C” between the weight (I) of the fluororesin ionomer and the weight (C) of the carbon carrier of the metal-supported catalyst which is an index of the total amount of the fluororesin ionomer increases, an amount of the fluororesin ionomer on the surface of the catalyst layer increases, and accordingly, when “the value “X” obtained when D (nm),” “A,” and “I/C” are applied to the above Formula (1) is a certain value or more as described above, the peel strength between the catalyst layer and the gas diffusion layer is high.

Here, in the present disclosure, “D (nm),” “A,” and “I/C” of a material used for producing a catalyst layer for a fuel cell electrode and “D (nm),” “A,” and “1/C” of the catalyst layer for a fuel cell electrode are substantially the same value, and these values are not substantially changed by production.

As the carbon carrier of the metal-supported catalyst in the catalyst layer for a fuel cell electrode of the present disclosure, a carbon carrier known in the technical field can be used. For example, the carbon carrier includes a carbon compound typified by silicon carbide in addition to a carbon material such as carbon black, mesoporous carbon, carbon nanotubes, and carbon nanofibers, but the present disclosure is not limited thereto.

A specific surface area of the carbon carrier of the metal-supported catalyst used for the catalyst layer for a fuel cell electrode of the present disclosure according to a BET method is not limited, and is generally 1500 m²/g or less, preferably 800 m²/g or less, and more preferably 500 m²/g or less.

As the carbon carrier of the metal-supported catalyst in the catalyst layer for a fuel cell electrode of the present disclosure, carbon black is preferable.

The metal catalyst of the metal-supported catalyst in the catalyst layer for a fuel cell electrode of the present disclosure is supported on the carbon carrier. The metal catalyst is supported on the surface of the carbon carrier or in pores.

The metal catalyst is not limited as long as it exhibits a catalytic action in the reaction of the electrode of the MEA and a metal catalyst known in the technical field can be used.

O₂+4H⁺+4e⁻→2H₂O air electrode (cathode):

2H₂→4H⁺+4e⁻ fuel electrode (anode):

The metal catalyst includes, for example, a noble metal, for example, platinum (Pt), and a noble metal alloy, for example, a platinum alloy, for example, platinum cobalt, platinum nickel, platinum ruthenium, platinum molybdenum, platinum osmium, platinum rhodium, platinum iron, platinum titanium, platinum tungsten, platinum palladium, platinum rhenium, platinum iridium, platinum chromium, platinum manganese, platinum niobium, and platinum tantalum, but the present disclosure is not limited thereto.

As the metal catalyst of the metal-supported catalyst in the catalyst layer for a fuel cell electrode of the present disclosure, platinum is preferable.

As the fluororesin ionomer used for the catalyst layer for a fuel cell electrode of the present disclosure, a fluororesin ionomer known in the technical field can be used. The fluororesin ionomer includes, for example, a perfluorosulfonic acid resin material (for example, Nafion), but the present disclosure is not limited thereto.

The catalyst layer for a fuel cell electrode of the present disclosure can be used as the air electrode and/or the fuel electrode included in the MEA or MEGA included in various electrochemical devices such as a solid polymer fuel cell.

The catalyst layer for a fuel cell electrode of the present disclosure can be prepared by a known method in the technical field provided that the value “X” obtained when the primary particle diameter “D (nm)” of the carbon carrier measured with an SEM, the catalyst water immersion pH value “A,” and the ratio “I/C” between the weight (I) of the fluororesin ionomer and the weight (C) of the carbon carrier of the metal-supported catalyst are applied to the above Formula (1) is a certain value or more as described above. The catalyst layer for a fuel cell electrode of the present disclosure can be prepared, for example, as follows.

(i) Step of Preparing a Metal-Supported Catalyst by Supporting a Metal Catalyst on a Carbon Carrier

A carbon carrier and an oxidized metal catalyst precursor are suspended in a solvent, for example, pure water, at room temperature to 100° C., for example, at room temperature, to obtain a suspension. In the obtained suspension, the metal catalyst precursor is reduced to a metal catalyst using a reducing agent, for example, ethanol or sodium borohydride, at room temperature to 100° C., for example, 60° C., to obtain a dispersion. The obtained dispersion is filtered, and the obtained cake is dried at 80° C. to 120° C., for example, 100° C., for 1 hour to 12 hours, for example, 12 hours, to obtain powder. The obtained powder is calcined under an inert atmosphere, for example, under a nitrogen atmosphere, at 100° C. to 1200° C., for example, 600° C., for 1 hour to 8 hours, for example, 3 hours, to obtain a metal-supported catalyst. Here, the calcination is performed to improve durability when the metal-supported catalyst is used at a high temperature. The calcination is performed in a range in which the primary particle diameter of the carbon carrier measured with an SEM does not change.

(ii) Step of Adjusting a Catalyst Water Immersion pH Value of the Metal-Supported Catalyst Prepared in (i)

The metal-supported catalyst prepared in (i) is suspended in a solvent, for example, pure water, at room temperature, to obtain a suspension. An acid, for example, nitric acid, is added to the obtained suspension to proceed with an acid treatment at room temperature to 100° C., for example, 60° C., for 1 minute to 10 minutes, for example, 10 minutes, to obtain a dispersion. Here, the acid treatment on the suspension is performed so that the catalyst water immersion pH value of the metal-supported catalyst becomes a desired value. The obtained dispersion is filtered, and the obtained cake is dried at room temperature to 120° C., for example, 100° C., for 1 hour to 12 hours, for example, 12 hours, to obtain powder.

(iii) Step of Mixing the Metal-Supported Catalyst Whose Catalyst Water Immersion pH Value is Adjusted in (ii) with a Fluororesin Ionomer to Prepare a Catalyst Ink

The metal-supported catalyst whose catalyst water immersion pH value is adjusted in (ii) and a fluororesin ionomer are suspended in a solvent, for example, pure water, at room temperature to 50° C., for example, 40° C., to obtain a suspension. An organic solvent, for example, ethanol, is added to the obtained suspension, and additionally, a known dispersion method, for example, ultrasonic dispersion, is performed thereon, at room temperature to 50° C., for example, 40° C., for 10 minutes to 120 minutes, for example, 120 minutes, to prepare a catalyst ink.

(iv) Step of Preparing a Catalyst Layer from the Catalyst Ink Prepared in (iii)

The catalyst ink prepared in (iii) is applied to a peelable base material, for example, a Teflon sheet, at room temperature to 40° C., for example, 40° C., using a known spraying, adhering and coating method, for example, a method using gravity, spray power, or an electrostatic force, for example, an applicator, to form a catalyst layer precursor. The catalyst layer precursor on the base material is dried at 40° C. to 150° C., for example, 80° C., for 1 hour to 12 hours, for example, 1 hour, using a known drying method, for example, an air dryer, volatile substances such as a solvent are removed, a catalyst layer is prepared, the catalyst layer is peeled off from the base material, and thus the catalyst layer is obtained.

Here, while a case in which the catalyst ink is sprayed, adhered, and applied to the base material, and then drying and peeling off are performed to obtain a catalyst layer has been described, the catalyst ink may be directly sprayed, adhered, and applied to a surface of a solid polymer electrolyte film and then dried so that it is possible to provide a state in which the catalyst layer and the solid polymer electrolyte film are bonded.

In Steps of (i) to (iv), an order of adding materials and a method of adding materials are not limited.

The catalyst layer for a fuel cell electrode of the present disclosure obtained as described above can be used as the air electrode and/or the fuel electrode included in the MEA or MEGA included in various electrochemical devices such as a solid polymer fuel cell.

Moreover, for example, the MEGA can be prepared using the catalyst layer for a fuel cell electrode of the present disclosure as follows.

(v) Step of Preparing the MEGA by Combining the Catalyst Layer Prepared in (iv), a Solid Polymer Electrolyte Film, and a Gas Diffusion Layer

The obtained catalyst layer is used as an air electrode and a fuel electrode, and the air electrode is disposed on one surface and the fuel electrode is disposed on the other surface of the solid polymer electrolyte film to obtain a layer assembly. Here, the air electrode and the fuel electrode are prepared to be adapted to electrodes by changing a metal catalyst used or the like. Further, the gas diffusion layer is disposed on the outer side the air electrode and the fuel electrode.

Here, the solid polymer electrolyte film is, for example, Nafion (Du Pont) or FLEMION (Asahi Glass Co., Ltd.), but the present disclosure is not limited thereto.

In addition, the gas diffusion layer is, for example, PYROFIL (Mitsubishi Chemical Corporation), but the present disclosure is not limited thereto.

The layer assembly in which the gas diffusion layer, the air electrode, the solid polymer electrolyte film, the fuel electrode, and the gas diffusion layer are disposed in that order is compression bonded at 80° C. to 200° C., for example, 140° C., at a pressure of 1 MPa to 8 MPa, for example, 5 MPa, for 10 seconds to 600 seconds, for example, 120 seconds, by hot pressing to obtain an MEGA.

In the MEGA prepared using the catalyst layer for a fuel cell electrode of the present disclosure, the peel strength between the catalyst layer and the gas diffusion layer, that is, the peel strength between the MEA and the gas diffusion layer is high.

When the catalyst layer for a fuel cell electrode of the present disclosure is used for various electrochemical devices such as a solid polymer fuel cell, it is possible to improve battery performance of the device.

Several examples related to the present disclosure will be described below. However, this is not intended to limit the present disclosure to that described in such examples.

1. Preparation of Samples

### Example 1: Preparation of Electrode Sheet (“X”=22)

### (i) Step of Preparing a Metal-Supported Catalyst by Supporting a Metal Catalyst on a Carbon Carrier

A carbon carrier (carbon black, 7 g) with “D (nm)”=23 (nm) (SEM) and a dinitro diamine platinum nitric acid solution containing 3 g of platinum were suspended in pure water (600 ml) at room temperature to obtain a suspension. In the obtained suspension, a platinum raw material was reduced to platinum using 99.5% ethanol (50 g) at room temperature to 100° C. to obtain a dispersion. The obtained dispersion was filtered, and the obtained cake was dried at 80° C. to 120° C. for 1 hour to 12 hours to obtain powder. The obtained powder was calcined at 100° C. to 1200° C. for 1 hour to 8 hours to obtain a platinum-supported catalyst.

(ii) Step of Adjusting a Catalyst Water Immersion pH Value of the Metal-Supported Catalyst Prepared in (i)

The platinum-supported catalyst prepared in (i) was suspended in pure water at room temperature to obtain a suspension. Nitric acid was added to the obtained suspension to proceed with an acid treatment at room temperature to 100° C. for 1 minute to 10 minutes to obtain a dispersion. Here, the acid treatment on the suspension was performed so that “A”=3.5 was obtained. The obtained dispersion was filtered, and the obtained cake was dried at room temperature to 120° C. for 12 hours to obtain powder.

(iii) Step of Mixing the Metal-Supported Catalyst Whose Catalyst Water Immersion pH Value was Adjusted in (ii) with a Fluororesin Ionomer to Prepare a Catalyst Ink

The platinum-supported catalyst (1 g) whose catalyst water immersion pH value was adjusted in (ii) and Nafion (0.84 g) which is a fluororesin ionomer were suspended in pure water (15 ml) at room temperature to 50° C. to obtain a suspension (“I/C”=1.2). Ethanol was added to the obtained suspension, and additionally, ultrasonic dispersion was performed at room temperature to 50° C. for 10 minutes to 120 minutes to prepare a catalyst ink.

(iv) Step of Preparing a Catalyst Layer (Electrode Sheet) from the Catalyst Ink Prepared in (iii)

The catalyst ink prepared in (iii) was applied to a substrate (Teflon) which is a base material, at room temperature using an applicator (3 mil) to form a catalyst layer precursor. The catalyst layer precursor on the substrate was dried at 40° C. to 150° C. for 1 hour to 12 hours using an air dryer to prepare a catalyst layer.

Here, in Step (iv), the obtained catalyst layer formed an electrode sheet (catalyst layer-substrate) together with the substrate (Teflon).

“D (nm)”=23 (nm)

### “A”=3.5

### “I/C”=1.2

### Example 2: Preparation of Electrode Sheet (“X”=28)

An electrode sheet was prepared in the same manner as in Example 1 except that an amount of the fluororesin ionomer was changed so that “I/C”=1.6 in Step (iii).

“D (nm)”=23 (nm)

### “A”=3.5

### “I/C”=1.6

### Example 3: Preparation of Electrode Sheet (“X”=28)

An electrode sheet was prepared in the same manner as in Example 1 except that a carbon carrier with “D (nm)”=40 (nm) was used in Step (i) and the acid treatment on the suspension was performed so that “A”=4.0 in Step (ii).

“D (nm)”=40 (nm)

### “A”=4.0

### “I/C”=1.2

### Example 4: Preparation of Electrode Sheet (“X”=30)

An electrode sheet was prepared in the same manner as in Example 1 except that a carbon carrier with “D (nm)”=40 (nm) was used in Step (i), and the acid treatment on the suspension was performed so that “A”=3.2 in Step (ii).

“D (nm)”=40 (nm)

### “A”=3.2

### “I/C”=1.2

### Example 5: Preparation of Electrode Sheet (“X”=20)

An electrode sheet was prepared in the same manner as in Example 1 except that the acid treatment on the suspension was performed so that “A”=4.5 in Step (ii).

“D (nm)”=23 (nm)

### “A”=4.5

### “I/C”=1.2

### Example 6: Preparation of Electrode Sheet (“X”=20)

An electrode sheet was prepared in the same manner as in Example 1 except that a carbon carrier with “D (nm)”=18 (nm) was used in Step (i).

“D (nm)”=18 (nm)

### “A”=3.5

### “I/C”=1.2

### Comparative Example 1: Preparation of Electrode Sheet (“X”=14)

An electrode sheet was prepared in the same manner as in Example 1 except that the acid treatment on the suspension was performed so that “A”=7.4 in Step (ii).

“D (nm)”=23 (nm)

### “A”=7.4

### “I/C”=1.2

### Comparative Example 2: Preparation of Electrode Sheet (“X”=16)

An electrode sheet was prepared in the same manner as in Example 1 except that an amount of the fluororesin ionomer was changed so that “I/C”=0.8 in Step (iii).

“D (nm)”=23 (nm)

### “A”=3.5

### “I/C”=0.8

### Comparative Example 3: Preparation of Electrode Sheet (“X”=14)

An electrode sheet was prepared in the same manner as in Example 1 except that a carbon carrier with “D (nm)”=18 (nm) was used in Step (i), and the acid treatment on the suspension was performed so that “A”=6.7 in Step (ii).

“D (nm)”=18 (nm)

### “A”=6.7

### “I/C”=1.2

2. Sample Evaluation

### Example 7: Measurement of Peel Strength

The peel strengths of the electrode sheets prepared in Examples 1 to 6 and Comparative Examples 1 to 3 were measured according to the following procedures.

(1) The electrode sheets prepared in Examples 1 to 6 and Comparative Examples 1 to 3 and gas diffusion layers (a complex of carbon fibers and MPL carbon) were cut to 3.6 cm×3.6 cm.
(2) With the electrode sheets and the gas diffusion layers cut in (1), the gas diffusion layer was superimposed on the side of the catalyst layer of the electrode sheet, and thermocompression bonding was performed thereon under conditions of 100° C. and 4 MPa for 4 minutes by hot pressing to prepare an electrode sheet and gas diffusion layer assembly.
(3) An iron plate was prepared and a double-sided tape was attached thereto.
(4) The electrode sheet and gas diffusion layer assembly prepared in (2) and the plate prepared in (3) were attached so that the gas diffusion layer of the assembly and the double-sided tape on the plate were adhered to each other.
(5) A drafting tape (3M drafting tape) was attached to the substrate of the electrode sheet of the assembly prepared in (4) to protrude 3 cm to 5 cm from the substrate.
(6) A weight was attached to the protrusion part of the tape attached in (5) and hung.
(7) A weight of the weight attached in (6) was gradually increased and a weight W (g) of the weight when the catalyst layer was peeled off was measured.
(8) The peel strength S was calculated by applying W measured in (7) to the following formula.

S=W×0.0098÷0.036 (N/m)

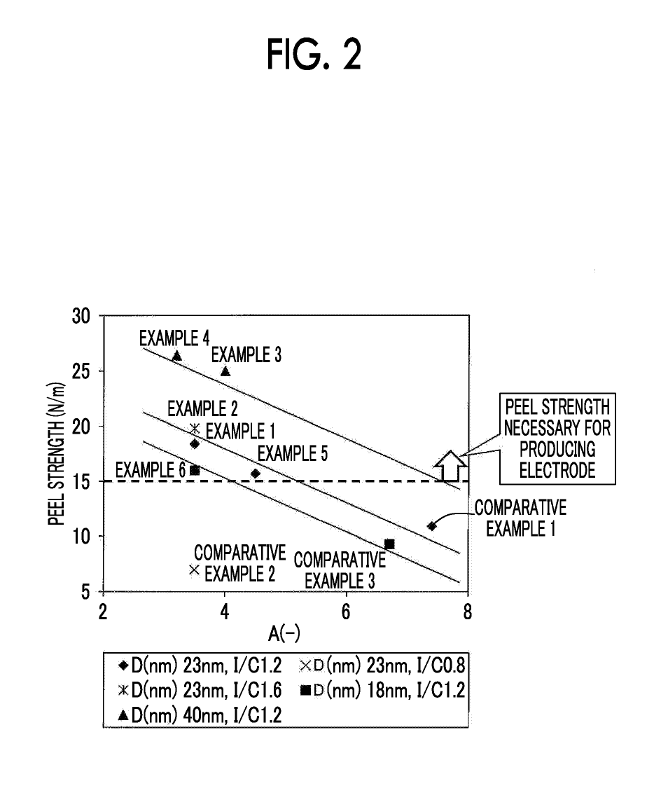

The results are shown in Table 1 and FIG. 2.

TABLE 1

| | | | | | Peel strength |
|---|---|---|---|---|---|
| | D (nm) | A (—) | I/C (—) | X (—) | (N/m) |
| Example 1 | 23 | 3.5 | 1.2 | 22 | 18.4 |
| Example 2 | 23 | 3.5 | 1.6 | 28 | 19.8 |
| Example 3 | 40 | 4.0 | 1.2 | 28 | 25.0 |
| Example 4 | 40 | 3.2 | 1.2 | 30 | 26.4 |
| Example 5 | 23 | 4.5 | 1.2 | 20 | 15.7 |
| Example 6 | 18 | 3.5 | 1.2 | 20 | 16.0 |
| Comparative | 23 | 7.4 | 1.2 | 14 | 10.9 |
| Example 1 | | | | | |
| Comparative | 23 | 3.5 | 0.8 | 16 | 7.0 |
| Example 2 | | | | | |
| Comparative | 18 | 6.7 | 1.2 | 14 | 9.3 |
| Example 3 | | | | | |

Straight lines in FIG. 2 are a regression line obtained from the relationship between “A” and the peel strength of electrode sheets having the same “D (nm)” and “I/C,” a regression line obtained from the relationship between “A” and the peel strength of the electrode sheets of Example 4 and Example 3 in descending order of peel strength, a regression line obtained from the relationship between “A” and the peel strength of the electrode sheets of Example 1, Example 5, and Comparative Example 1, and a regression line obtained from the relationship between “A” and the peel strength of the electrode sheets of Example 6 and Comparative Example 3.

Based on Table 1 and FIG. 2, regarding the peel strength between the catalyst layer and the gas diffusion layer,

(1) the peel strength is higher when the primary particle diameter “D (nm)” of the carbon carrier measured with an SEM is larger,
(2) the peel strength is higher when the catalyst water immersion pH value “A” is smaller, and
(3) the peel strength is higher when the ratio “I/C” between the weight (I) of the fluororesin ionomer and the weight (C) of the carbon carrier of the metal-supported catalyst is higher, and particularly, the peel strength is significantly high in the electrode sheets prepared in Examples 1 to 6 in which the value “X” obtained when “D (nm),” “A,” and “I/C” are applied to X=0.42×D−1.96×A+16×I/C satisfies X≥18.

What is claimed is:

1. A catalyst layer for a fuel cell electrode comprising a metal-supported catalyst including a carbon carrier and a metal catalyst supported on the carbon carrier, and a fluororesin ionomer,
wherein, when a primary particle diameter of the carbon carrier measured with an SEM is set as D (nm), a pH value of a suspension obtained when 0.5 g of the metal-supported catalyst is suspended in 30 ml water and then stirred for 30 minutes is set as A, a weight of the fluororesin ionomer is set as I, and a weight of the carbon carrier of the metal-supported catalyst is set as C, a following formula is satisfied.
0.42×D−1.96×A+16×I/C≥18

2. A method of producing a catalyst layer for a fuel cell electrode including a metal-supported catalyst and a fluororesin ionomer, comprising:
preparing a metal-supported catalyst by supporting a metal catalyst on a carbon carrier;
adjusting a pH value of a suspension of the prepared metal-supported catalyst obtained when 0.5 g of the metal-supported catalyst is suspended in 30 ml water and then stirred for 30 minutes;
preparing a catalyst ink by mixing the metal-supported catalyst whose pH value is adjusted with a fluororesin ionomer; and
preparing a catalyst layer for a fuel cell electrode from the prepared catalyst ink,
wherein, when a primary particle diameter of the carbon carrier measured with an SEM is set as D (nm), the pH value is set as A, a weight of the fluororesin ionomer is set as I, and a weight of the carbon carrier of the metal-supported catalyst is set as C, the following formula is satisfied.
0.42×D−1.96×A+16×I/C≥18
